(19) United States
(12) Patent Application Publication
(10) Pub. No.: US 2024/0423200 A1
(43) Pub. Date: Dec. 26, 2024

(54) FOAMING COMPOSITIONS FOR CONTROLLING ARTHROPODS

(71) Applicant: The Procter & Gamble Company, Cincinnati, OH (US)

(72) Inventors: Michael David O'Young MUI, Mason, OH (US); Morgan Renee SAILOR, Cincinnati, OH (US)

(21) Appl. No.: 18/748,207

(22) Filed: Jun. 20, 2024

Related U.S. Application Data
(60) Provisional application No. 63/603,884, filed on Nov. 29, 2023.
(60) Provisional application No. 63/509,380, filed on Jun. 21, 2023.

(51) Int. Cl. A01N 25/16; A01N 31/02; A01N 65/22; A01P 7/04

(52) U.S. Cl. CPC A01N 25/16; A01N 31/02; A01N 65/22; A01P 7/04

(57) ABSTRACT

The present disclosure relates to a foaming pest control product and to methods for controlling pests, such as insects and other arthropods. More particularly, the disclosure relates to a pest control product containing a composition that foams when dispensed, where the properties of the foam are selected to provide an optimal usage experience and efficacy.

### CROSS REFERENCE TO RELATED APPLICATIONS

This application claims the benefit of U.S. Provisional Application No. 63/603,884, filed Nov. 29, 2023, and U.S. Provisional Application No. 63/509,380, filed Jun. 21, 2023, the entire disclosures of which are fully incorporated by reference herein.

### FIELD OF THE INVENTION

The present disclosure relates to a foaming pest control product and to methods for controlling pests, such as insects and other arthropods. More particularly, the disclosure relates to a pest control product containing a composition that foams when dispensed, where the properties of the foam are selected to provide an optimal usage experience and efficacy.

### BACKGROUND OF THE INVENTION

Insects and other arthropod pests can have negative effects on the quality of human life. For instance, when found in the home, insects and other arthropods can be a source of annoyance due purely to their presence. They may also spread disease and allergens. A number of pest control products exist today to control various pests and the market for pest control products, especially products that contain natural ingredients (e.g., plant essential oils), is growing. While products that contain natural ingredients exist today, they may have a number of disadvantages: some products have limited efficacy; some products are not recommended for use on food contact surfaces; some products do not provide an optimal scent experience, e.g., emit a long-lasting, unpleasant odor; some products do not provide optimal neat product aesthetics, e.g., appear cloudy, or turbid, and/or off color; some products may be phase unstable at cold temperatures (i.e., about 5° C. to 10° C.) or separate into multiple phases and require a consumer to vigorously shake the product before use; and some products may be messy to use and/or may leave a residue on a treated surface.

Furthermore, the direct application of many existing pest control compositions (including those that contain synthetic ingredients as well as those that contain natural ingredients) to a pest involves monitoring by a consumer to determine product efficacy. For example, after a consumer applies a pest control composition to a target pest (e.g., ants, flies, cockroaches), the consumer typically observes the pest for signals of incapacitation, including twitching of wings, legs, or antennae and/or the inability of the pest to right itself. In addition, after a pest control composition is applied to a pest, the pest may attempt to run or fly away. Sometimes, a consumer may even feel compelled to prod or poke a pest, after application of the pest control composition. There is a need for a pest control product that involves less interaction or observation by the consumer after application, while still providing a sufficient signal of efficacy.

A foaming pest control product, such as a liquid pest control product that is converted to a foam upon dispensing, may address this need, as the foam may conceal the incapacitated pest from the consumer's view. However, existing foaming arthropod control products are designed to be sprayed on surfaces, rather than directly onto a pest. In particular, many existing foaming pest control products are designed for application to hard-to-reach spaces, where pests may live or hide, such as cracks and crevices, and the foam is designed to expand into the hard-to-reach space. For example, existing foaming wasp sprays are designed to be sprayed onto a wasp nest and the foam is designed to expand into the nest, and existing foaming termite sprays are designed to be sprayed on wood and the foam is designed to expand into the wood to contact the termites. Consequently, these existing foaming pest control products tend to generate a long lasting foam that is slow to collapse. However, such a long lasting foam is undesirable for a pest control product that is designed primarily for application directly to a pest. At the same time, though, a foam that is lose, thin, or too quick to collapse may also be undesirable, as such a foam may not trap and conceal the pest from the consumer's view.

A pest control product that contains a liquid pest control composition, which is dispensed in the form of a foam having selected properties optimized for direct application to a pest, is disclosed herein. Also, the liquid pest control composition disclosed herein comprises natural or renewable ingredients, which can pose formulation challenges when designed for dispensing as a foam.

### SUMMARY OF THE INVENTION

Described herein is a pest control composition comprising (a) a foam dispenser attached to a reservoir, (b) a pest control composition contained in the reservoir and comprising: (i) from about 1% to about 10% by weight of the composition of sodium lauryl sulfate; (ii) from about 0.005% to about 15% by weight of the composition of an active ingredient chosen from cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof, preferably chosen from geraniol, cornmint oil, peppermint oil, spearmint oil, rosemary oil, lemongrass oil, or mixtures thereof; (iii) from about 5% to about 35% by weight of the composition of a first solvent, where the first solvent is isopropyl alcohol; and (iv) from about 50% to about 95% by weight of the composition of water.

Described herein is a pest control product comprising (a) a foam dispenser attached to a reservoir, (b) a pest control composition contained in the reservoir, wherein the pest control composition comprises: (i) from about 0.2% to about 10% by weight of the composition of sodium lauryl sulfate; (ii) from about 0.005% to about 15% by weight of the composition of an active ingredient chosen from cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof; (iii) from about 2.5% to about 25% by weight of the composition of a first solvent, wherein the first solvent is isopropyl alcohol; and (iv) from about 50% to about 95% by weight of the composition of water. The weight ratio of sodium lauryl sulfate to isopropyl alcohol is from about 2:1 to about 1:12.

Described herein is a pest control composition comprising (a) from about 0.2% to about 10% by weight of the composition of sodium lauryl sulfate; (b) from about 0.005% to about 15% by weight of the composition of an active ingredient chosen from cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof; (c) from about 2.5% to about 25% by weight of the composition of a first solvent, wherein the first solvent is isopropyl alcohol; and (d) from about 50% to about 95% by weight of the composition of water. The pest control composition exhibits a 25% Liquid Drainage Time of from about 25 seconds to about 50 seconds as measured according to the Foam Lather Method. The pest control composition is a foam and the foam has a specific volume of from about 3 ml/g to about 20 ml/g.

Also described herein is a method of controlling a pest, the method comprising: applying a pest control composition to a pest; wherein the pest control composition comprises: (a) from about 0.2% to about 10% by weight of the composition of sodium lauryl sulfate; (b) from about 0.005% to about 15% by weight of the composition of an active ingredient chosen from cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof; (c) a first solvent, wherein the first solvent is isopropyl alcohol; and (d) from about 50% to about 95% by weight of the composition of water. The pest control composition is dispensed from a foam dispenser as a foam. The weight ratio of sodium lauryl sulfate to isopropyl alcohol is from about 2:1 to about 1:12.

### DETAILED DESCRIPTION OF THE INVENTION

Consumers are looking for effective and natural ways to control a variety of arthropods. However, existing pest control products that contain natural ingredients are often messy to use, phase unstable at some or all consumer relevant temperatures, and/or provide an unpleasant consumer experience, such as by requiring a consumer to shake the product before use and/or by appearing off color. Additionally, the direct application of most existing pest control compositions (including those that contain synthetic ingredients as well as those that contain natural ingredients) to a pest involves monitoring the pest for signals of incapacitation, including twitching of wings, legs, or antennae and/or the inability of the pest to right itself. A pest control product that dispenses a foaming pest control composition may be desirable, as the foam may conceal, immobilize, and/or trap the pest. Preferably, the properties of the foam are selected such that the foam is sufficiently thick to conceal the pest but does not last for an overly extended period of time and/or require extensive wiping by a consumer to remove. Described herein is a substantially clear, substantially colorless, stable (preferably not requiring shaking before use) aqueous pest control composition that, upon dispensing, generates a foam, which conceals the target pest but collapses in an appropriate amount of time, without requiring extensive wiping or labor by a consumer to clear the foam. The pest control composition described herein can deliver a consumer preferred foaming experience for direct application to a pest while still delivering efficacy and consumer acceptable scent intensity by balancing the levels of essential oils, surfactant, one or more solvents, and water in a foam dispenser.

In some aspects, the pest control composition may be an arthropod pest control composition.

As used herein, “stable” refers to a pest control composition that is substantially clear and free from phase separation or precipitation, where no agitation or mixing is required to use the pesticidal composition for its application. The aqueous pesticidal compositions described herein are less messy to use, easy to clean up, help conceal the target pest during use, and have acceptable product scent, aesthetics, or other characteristics, e.g., can be used on food contact surfaces.

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

The compositions of the present disclosure can comprise, consist essentially of, or consist of, the essential components as well as optional ingredients described herein. As used herein, “consisting essentially of” means that the composition or component may include additional ingredients, but only if the additional ingredients do not materially alter the basic and novel characteristics of the claimed compositions or methods.

As used herein, articles such as “a” and “an” when used in a claim, are understood to mean one or more of what is claimed or described.

As used herein, the terms “include”, “includes” and “including” are meant to be non-limiting.

The term “renewable” is synonymous with the terms “natural,” “bio-derived”, “bio-based,” and means that a material is derived from substances derived from living organisms, such as farmed plants, rather than, for example, geologically derived, e.g., coal-derived or petroleum-derived.

As used herein, the term “anti-foam” refers to a chemical compound of which the principle intended function is to depress foaming or suds caused by surfactants. Examples of anti-foams include silicone antifoam compounds and paraffin antifoam compounds and mixtures thereof.

“Geologically derived” means derived from, for example, petrochemicals, natural gas, or coal. “Geologically derived” materials cannot be easily replenished or regrown (e.g., in contrast to plant- or algae-produced materials).

As used herein, the term “renewable component” refers to a component that is derived from renewable feedstock and contains renewable carbon. A renewable feedstock is a feedstock that is derived from a renewable resource, e.g., plants, and non-geologically derived. A material may be partially renewable (less than 100% renewable carbon content, from about 1% to about 90% renewable carbon content, or from about 1% to about 80% renewable carbon content, or from about 1% to about 60% renewable carbon content, or from about 1% to about 50% renewable carbon content) or 100% renewable (100% renewable carbon content). A renewable feedstock may be blended or chemically reacted with a geologically derived feedstock, resulting in a material with a renewable component and a geologically derived component.

“Renewable carbon” may be assessed using the “Assessment of the Biobased Content of Materials” method, ASTM D6866-16.

As used herein, the term “natural oils” means oils that are derived from plant or algae matter (also referred to as renewable oils). Natural oils are not based on kerosene or other fossil fuels. The term “oils” include fats, fatty acids, waste fats, oils, or mixtures thereof. A natural oil typically includes triglycerides, free fatty acids, or a combination of triglycerides and free fatty acids, and other trace compounds.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, less than about 0.25%, less than about 0.1%, less than about 0.05%, or less than about 0.01% by weight of the composition, of the component.

As used herein the term “dye” includes aesthetic dyes that modify the aesthetics of the pest control composition. Dyes include colorants and pigments.

Volatile Organic Compounds (VOCs) are identified by the U.S. Environmental Protection Agency (EPA) as organic compounds that participate in atmospheric photochemical reactions, with the exception of compounds that have negligible photochemical reactivity. VOCs are generally emitted as gases from certain solids or liquids. Pesticides may be formulated to contain 40% by weight VOC, or less.

As used herein, the terms “control” or “controlling” are meant to include, but are not limited to, any killing, inhibiting, growth regulating, deterring, repelling, immobilizing, attracting, or pestistatic (inhibiting or otherwise interfering with the normal life cycle of the pest) activities of a composition against a given pest.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Foam

A foaming pest control composition may be generated by and/or upon dispensing a liquid pest control composition (e.g., an aqueous pest control composition) through a foam dispenser, such as a mechanical foam dispenser or an aerosol foam dispenser. Alternatively, a foaming pest control composition may be sold or marketed in the form of a ready-to-use foam (thereby not requiring a foam dispenser). Alternatively, a foaming pest control composition may be generated by and/or upon dispensing a liquid pest control composition from a pressurized aerosol reservoir.

Generally, a foam contains bubbles that sustain their shape and give a volume independent of any type of container. The foam may comprise a uniform bubble size or it may comprise a range or distribution of bubble sizes. The foam may have a specific volume ranging from about 6 ml/g to about 14 ml/g, or from about 7.5 ml/g to about 12 ml/g, or from about 8 ml/g to about 10.5 ml/g, immediately after dispensing. In some aspects, the foam may have a specific volume ranging from about 3 ml/g to about 20 ml/g, or from about 4 ml/g to about 18 ml/g, or from about 5 ml/g to about 15 ml/g, immediately after dispensing. Specific volume can be measured according to the Specific Volume Method described herein. A foam that is too “airy” (e.g., a Specific Volume greater than about 20 ml/g) may cause a consumer to apply greater amounts of the foaming pest control composition, as the concentration of actives may be too low to effectively control the pest in foams with a Specific Volume greater than 20 ml/g. Conversely, a foam with a Specific Volume less than 3 ml/g may not have sufficient aeration to sufficiently trap and/or conceal a pest.

Preferably, the foam maintains its volume immediately after dispensing and at least long enough to transfer from a dispenser to a target pest and act to incapacitate the pest. The foam may substantially maintain its volume is for at least 10 seconds, or at least 15 seconds, or at least 20 seconds, or at least 25 seconds, or at least 30 seconds, or at least 40 seconds, or at least 50 seconds, or at least 60 seconds. Preferably, the foam also collapses in an appropriate amount of time, without intervention by a consumer. The foam may substantially collapse in less than 300 seconds, or less than 240 seconds, or less than 180 seconds, or less than 120 seconds, or less than 100 seconds after dispensing. If the pest control composition foam collapses prematurely and becomes liquid, the pest control composition may not sufficiently conceal the target pest and the composition may puddle or flow away from the target pest. This may negatively affect the efficacy of the pest control product and/or allow the pest to escape. Also, the foaming dispenser is preferably selected to convert the liquid pest control composition into a foam and dispense it as a foam, with minimal or no sputtering or liquid leakage from the container storing the liquid composition, which is attached to the dispenser.

The pest control composition described herein may comprise a foam or generate a foam, when dispensed, that has a Foam Collapse Rate ranging from about 0.20 mm/sec to about 1.2 mm/sec, or from about 0.40 mm/sec to about 1 mm/sec, or from about 0.50 mm/sec to about 0.80 mm/sec, as measured by the Foam Collapse Test Method described hereafter.

The pest control composition may comprise a foam or generate a foam, when dispensed, that has a Foam Decay Rate of from about 0.20 mm/sec to about 1.0 mm/sec, or from about 0.30 mm/sec to about 0.80 mm/sec, or from about 0.40 mm/sec to about 0.60 mm/sec, as measured by the Foam Lather Method as described herein.

The Foam Collapse Rate and/or Foam Decay Rate of the composition may be selected such that the target pest is covered by the foam long enough to conceal the pest's incapacitation, but not so long that wiping, cleaning, and/or removal of the foam may be needed. Without being limited by theory, it is believed that if a pest control composition exhibits a Foam Collapse Rate and/or a Foam Decay rate greater than the range described above, the foam may collapse prematurely and turn into liquid, reducing the ability of the composition to conceal the target pest effectively and potentially allowing the pest to escape, thus reducing the product's efficacy. It is believed that if a pest control composition exhibits a Foam Collapse Rate and/or Foam Decay rate lower than the range described above, the foam may be difficult for the consumer to clean up after use.

The pest control composition may have a 25% Liquid Drainage Time of from about 25 seconds to about 50 seconds, or from about 30 seconds to about 40 seconds, as measured by the Foam Lather Method.

The pest control composition may have a Drainage Half-Life Time of from about 32 seconds to about 70 seconds, or from about 40 seconds to about 55 seconds, as measured by the Foam Lather Method.

The 25% Liquid Drainage Time and/or Drainage Half-Life Time of the composition may be selected such that the target pest is covered by the foam long enough to conceal the pest's incapacitation, but not so long that wiping, cleaning, and/or removal of the foam may be needed. Without being limited by theory, it is believed that if a pest control composition exhibits a 25% Liquid Drainage Time and/or Drainage Half-Life Time shorter than the range described above, the foam may collapse prematurely and turn into liquid, reducing the ability of the composition to conceal the target pest effectively and potentially allowing the pest to escape, thus reducing the product's efficacy. It is believed that if a pest control composition exhibits a 25% Liquid Drainage Time and/or Drainage Half-Life Time longer than the range described above, the foam may be difficult for the consumer to clean up after use.

The pest control composition may have a Max Foam Volume of from about 130 mL to about 180 mL, or from about 140 mL to about 160 mL, or 145 mL to about 155 mL, as measured by the Foam Lather Method. It is believed that compositions having a Max Foam Volume of less than about 130 mL may not create sufficient foam to conceal the target pest effectively and compositions having a Max Foam Volume greater than about 180 mL may create too much foam resulting in a composition that is difficult to clean up or is less effective at controlling the pest.

The pest control composition may have an Initial Bubble Count of from about 80 mm⁻² to about 150 mm⁻², or from about 100 mm⁻² to about 135 mm⁻², or from about 105 mm⁻² to about 130 mm⁻², as measured by the Foam Lather Method. Without being limited by theory, it is believed that by having an Initial Bubble Count of at least 80 mm⁻², more preferably of at least 100 mm⁻², the foam will have more densely packed bubbles that can help trap and/or conceal the pest in the time initially after spraying on the pest. In some aspects, the pest control composition may have a Final Bubble Count that is less than the Initial Bubble Count. In some aspects, the pest control composition may have an Initial Bubble Count of from about 50 mm⁻² to about 90 mm⁻², or from about 60 mm⁻² to about 85 mm⁻², or from about 70 mm⁻² to about 80 mm⁻², as measured by the Foam Lather Method. It may be desirable to have a delta between the Initial Bubble Count and the Final Bubble Count (referred to as “Delta Bubble Count”) of at least 20 mm⁻², or from 20 mm⁻² to about 70 mm⁻², or from about 30 mm⁻² to about 60 mm⁻², indicating that the foam structure is unstable and becoming a liquid, which may be more consumer preferable to clean up.

The pest control composition may have an Initial Average Bubble Radius of from about 40 μm to about 65 μm, or from about 45 μm to about 60 μm, as measured by the Foam Lather Method. Without being limited by theory, it is believed that if the Initial Average Bubble Radius is greater than about 65 μm, the bubbles of the foam may be too large to effectively trap and/or conceal the pest. In some aspects, the Final Average Bubble Radius may be less than the Initial Average Bubble Radius. In some aspects, the pest control composition may have a Final Average Bubble Radius of from about 40 μm to about 80 μm, or from about 45 μm to about 70 μm, or from about 50 μm to about 65 μm, as measured by the Foam Lather Method. In some aspects, it may be desirable to have a delta between the Initial Average Bubble Radius and the Final Average Bubble Radius (referred to herein as “Delta Bubble Radius”) of at least 9 μm, or from about 9 μm to about 20 μm, or from about 12 μm to about 15 μm, as it can indicate that the bubbles are getting larger over time as more of the bubbles start to pop and the foam collapses.

The pest control composition may have an Initial Sauter Mean Radius of from about 50 μm to about 125 μm, or from about 60 μm to about 115 μm, or from about 70 μm to about 100 μm, as measured by the Foam Lather Method. Without being limited by theory, it is believed that if the Initial Sauter Mean Radius is greater than about 125 μm, the bubbles of the foam may be too large to effectively trap and/or conceal the pest. In some aspects, the Final Sauter Mean Radius may be less than the Initial Sauter Mean Radius. In some aspects, the pest control composition may have a Final Sauter Mean Radius of from about 40 μm to about 180 μm, or from about 50 μm to about 170 μm, or from about 55 μm to about 150 μm, as measured by the Foam Lather Method. In some aspects, it may be desirable to have a delta between the Initial Sauter Mean Radius and the Final Sauter Mean Radius (referred to herein as “Delta Sauter Mean Radius”) of at least about 20 μm, or from about 20 μm to about 100 μm, or from about 30 μm to about 80 μm, as it can indicate that the bubbles are getting larger over time as more of the bubbles start to pop and the foam collapses.

### Pest Control Composition

The products and compositions disclosed herein may be useful for controlling a variety of pests, including arthropods, e.g., insects. Crawling arthropods include ants, beetles, carwigs, silverfish, crickets, spiders, centipedes, and the like. Flying arthropods include flying insects, such as flies, mosquitoes, gnats, moths, wasps, hornets, bees, and the like. Such pests may be found both outside and inside the home.

The pest control compositions are preferably in the form of liquids, which foam when dispensed. The pest control compositions are preferably aqueous compositions. Aqueous liquid compositions are convenient to use because these compositions can be readily applied directly to arthropod pests, without leaving residue on adjacent surfaces. The pest control composition may comprise from about 40% to about 95%, or from about 50% to about 90%, or from about 55% to about 80%, or from about 58% to about 78%, or from about 60% to about 75%, or from about 62% to about 72%, by weight of the total composition of water. The pest control compositions may be clear, as clarity may connote purity to the user. The pest control compositions may be provided in the form of a ready-to-use composition, which can be directly applied to arthropod pests (e.g., as a spray) and need not be diluted by a consumer before use. Ready-to-use compositions may be preferred by some consumers, because ready-to-use compositions do not require dilution by the consumer, which may be messy, inconvenient, and/or require multiple containers. The pest control compositions disclosed herein may contain select ingredients at select levels suitable to be sprayed directly onto arthropod pests.

The pest control compositions disclosed herein may be substantially free of geologically derived (e.g., petroleum-based) oils, such as mineral oil. Pest control compositions containing geologically derived oils, such as mineral oil, may also leave a residue on a treated surface and may be generally messy to use.

The pH of the pest control composition may be from about 3.0 to about 11.0, or from about 3.0 to about 10.0, or from about 3.0 to about 9.0, or from about 3.5 to about 9.5, or from about 4.0 to about 9.0, or from about 4.5 about 9.0, or from about 5.0 to about 8.5, or from about 5.5 to about 8.0. The pH of the composition may be adjusted using pH modifying ingredients known in the art.

The pest control composition may comprise particles having an intensity mean particle size from about 1 nm to about 500 nm, or from about 2 nm to about 250 nm, or from about 3 nm to about 1000 nm, or from about 5 nm to about 20 nm. Intensity mean intensity particle size can be measured according to the Particle Size Test Method described hereafter.

The pest control composition may comprise particles having a volume mean particle size from about 1 nm to about 500 nm, or from about 2 nm to about 100 nm, or from about 3 nm to about 50 nm, or from about 3 nm to about 20 nm. Volume mean intensity particle size can be measured according to the Particle Size Test Method described hereafter.

The pest control composition may comprise particles having a number mean particle size from about 1 nm to about 500 nm, or from about 2 nm to about 250 nm, or from about 3 nm to about 100 nm, or from about 5 nm to about 20 nm. Number mean intensity particle size can be measured according to the Particle Size Test Method described hereafter.

The compositions disclosed herein are preferably safe for application to surfaces that come in contact with food, surfaces adjacent to food contact surfaces, or food itself, where there is an increased likelihood that traces of the composition may be ingested. It is desirable for the materials incorporated in the pest control compositions disclosed herein to be “food compatible” or “food use safe.” Generally, residues from a food compatible or food use safe ingredient may remain on a food contact surface or a food itself, e.g., fruits or vegetables, and are safe for ingestion by humans and/or animals. Food compatible or food use safe ingredients include minimum risk pesticide ingredients listed under section 25 (b) of the Federal Insecticide, Fungicide, and Rodenticide Act (FIFRA) and identified, in the list, as “food use” ingredients (products intended for use on food-use sites (e.g., used on food, food crops, food contact surfaces, or animal feed commodities) can only include active ingredients with applicable tolerances or tolerance exemptions).

Food compatible or food use safe ingredients also include ingredients that are suitable for direct or indirect food contact use and/or which can be approved as GRAS, prior sanctioned, or subject to GRAS approval via a GRAS petition, and/or toxicologically acceptable to humans under usage conditions. Materials added to foods (additives) can be categorized as one of several types: (1) direct food additives; (2) indirect food additives; (3) GRAS ingredients (generally recognized as safe) either as direct or indirect food substances; (4) GRAS affirmed, a chemical which may be considered for GRAS classification after experts review adequate technical support data for the GRAS petition; and (5) prior sanctioned, a food ingredient of known food use and granted approval with respect to use of the substance in food prior to September 1958, by the FDA, or USDA.

Food additives include substances that, in use, may become or may reasonably be expected to become, directly or indirectly, a component of the food or may otherwise affect the characteristics of the food. Direct food additives are materials that are added directly to foods to achieve an intended purpose. Indirect food additives are materials that are not directly added to foods but may be mingled or mixed with the food by virtue of close contact with the food. For example, materials that are added to food containers and/or packages, may migrate to and/or mix with the food (stored in the container) due to the close proximity between the container/package and the food. Thus, materials used in the production of food containers and/or packaging materials may be considered indirect food additives.

Indirect food additives may include: (1) adhesives and components of coatings; (2) paper and paperboard components; (3) adjuvants, such as those used in the manufacture of foamed plastics, and sanitizers. Sanitizers used in food applications, as direct or indirect additives, include: (1) aqueous hypochlorite (K, Na or Ca salts); (2) aqueous solutions of dichloroisocyanuric acid, trichloroisocyanuric acid, or the sodium or potassium salts of these acids, either with, or without, the bromides of potassium, sodium, and/or calcium; (3) anionic surfactant solutions, such as dodecylbenzene sulfonic acid, and/or sodium lauryl sulfate; or mixtures of these together or with other anionic surfactants as allowed under FDA regulations; (4) aqueous fatty acid solutions containing decanoic acid, octanoic acid, lactic acid and other ingredients; (5) aqueous solutions comprised of hydrogen peroxide, peroxyacetic acid, acetic acid, sulfuric acid and other ingredients as allowed by FDA regulations: (6) quaternary sanitizers, such as di-n-alkyl (C8-10) dimethylammonium chloride and n-alkyl (C12-16) benzyl-dimethylammonium chloride; (7) aqueous solutions containing ortho-phenylphenol. ortho-benzyl-para-chlorophenol, para-tertiaryamylphenol and/or other ingredients as allowed under FDA regulations.

Ingredients added directly or indirectly to food can be affirmed as generally recognized as safe (GRAS). The GRAS ingredient may include any agent listed on the FDA's GRAS list, including direct food additives (see, e.g., US law (sections 201 (s) and 409 of the Federal Food, Drug, and Cosmetic Act, November 2016). The GRAS ingredient may also include, but is not limited to, agents that are generally recognized, among experts qualified by scientific training and experience to evaluate their safety, as having been adequately shown through scientific procedures (or, in the case of a substance used in food prior to Jan. 1, 1958, through either scientific procedures or through experience based on common use in food) to be safe.

The compositions disclosed herein may comprise at least one ingredient that is food compatible or food use safe, such as food grade ingredients or generally recognized as safe (GRAS) ingredients. Compositions comprising food compatible or food use safe ingredients may be used by consumers without rinsing or wiping a treated surface or treated food, e.g., fruits or vegetables, after use. The compositions disclosed herein may comprise ingredients that have a tolerance or tolerance exemption for use on food contact surfaces under the Federal Food, Drug, and Cosmetic Act US law (see, e.g., 40 CFR 180, November 2016, December 2015 update).

Direct GRAS ingredients may be used under current good manufacturing practice (GMP), which may require that a direct food additive is food grade, is prepared and handled as a food ingredient, and is added at an appropriate concentration (e.g., not exceeding the concentration that is reasonably required to accomplish an intended physical, nutritional, or other technical effect in the food). Indirect GRAS ingredients may also be used under current good manufacturing practice (GMP), which may require that an indirect food additive be of an appropriate purity and that the quantity of the indirect additive (e.g., added to food container, packaging, wrapper) not exceed the concentration that is reasonably required to accomplish an intended physical, nutritional, or other technical effect in the food container.

The pest control compositions disclosed herein may comprise ingredients eligible for minimum risk pesticide products listed under section 25 (b) of the Federal Insecticide, Fungicide, and Rodenticide Act (FIFRA) (also referred to as FIFRA 25 (b) exempt pesticides), incorporated herein by reference in its entirety. The compositions disclosed herein may comprise naturally occurring compounds or extracts or derivatives thereof. The compositions disclosed herein may comprise at least one organic, certified organic, US Department of Agriculture (“USDA”) National Organic Program compliant (“NOP-compliant”) ingredient.

The pest control compositions disclosed herein may comprise ingredients eligible for minimum risk pesticide products listed under section 25 (b) of the Federal Insecticide, Fungicide, and Rodenticide Act (FIFRA) (also referred to as FIFRA 25 (b) exempt pesticides), incorporated herein by reference in its entirety. The compositions disclosed herein may comprise naturally occurring compounds or extracts or derivatives thereof. The compositions disclosed herein may comprise at least one organic, certified organic, US Department of Agriculture (“USDA”) National Organic Program compliant (“NOP-compliant”) ingredient.

The compositions disclosed herein may comprise less than about 15 ingredients, less than 12 ingredients, preferably less than about 10 ingredients, more preferably less than about 15 ingredients and greater than about 5 ingredients.

The pest control compositions disclosed herein may have a relatively high level of clarity (i.e., low turbidity). Some consumers prefer a clear product versus a product that is cloudy or murky (i.e., higher turbidity). The compositions may exhibit a turbidity of less than about 100 NTU, preferably less than about 20 NTU, and greater than or equal to about 0 NTU. The compositions may exhibit a turbidity of from about 1 to about 20 NTU or from about 2 to about 10 NTU. Turbidity of the compositions is measured with a laboratory turbidity meter as described in the Test Methods section below.

The pest control compositions disclosed herein may have a reduced yellow color. Some composition ingredients, particularly some essential oils, may naturally yellow over time. Some consumers prefer a colorless or substantially colorless product versus a product that has a yellow color. The reduction of the yellow color may be measured by any colorimetric or spectrometric method known in the art. Suitable colorimetric analytical methods include, for example, the Gardner color scale (according to American Society for Testing and Materials (“ASTM”) method ASTM D1544, D6166 and/or American Oil Chemists' Society (“AOCS”) method AOCS Td-la-64); the CIELAB color scale (according to ASTM D5386-93b); the American Public Health Association (“APHA”) color scale (according to ASTM D1209 or AOCS Td-1b-64); the Saybolt color scale (according to ASTM D156 or D6045); or the Lovibond (red) scale (according to AOCS Cc-13b-45). The CIELAB color scale may be used to quantify the color of a pest control composition. The CIELAB color scale may also be referred to as L*a*b*, a color scale defined by the International Commission on Illumination (abbreviated CIE) in 1976. The CIELAB color scale expresses color as three values: L* for perceptual lightness, and a* and b* for the four unique colors of human vision: red, green, blue, and yellow, where the b* value represents blue/yellow color. It should be noted that the present disclosure is not limited to any specific colorimetric measurement and the reduction of the yellow color observed may be measured by any suitable colorimetric method.

The pest control compositions of the present disclosure may comprise renewable components and exhibit good efficacy against arthropod pests. The compositions disclosed herein may comprise from about 1%, or from about 5%, or from about 10%, or from about 20%, or from about 30%, or from about 40% or from about 50%, to about 40%, or to about 50%, or to about 60%, or to about 70%, or to about 80%, or to about 90%, or to about 100% by weight of renewable components. The compositions disclosed herein may be at least partially or fully bio-based. As such, the composition may comprise a bio-based carbon content of about 50% to about 100%, preferably about 70% to about 100%, more preferably about 75% to about 100%, even more preferably about 80% to about 100%, most preferably about 90% to about 100%. The percent bio-based carbon content can be calculated as the “percent Modern Carbon (pMC)” as derived using the methodology of ASTM D6866-16. The compositions of the present disclosure may be substantially free of petroleum-derived solvents or petroleum-derived surfactants.

The compositions disclosed herein may contain less than or equal to about 40% by weight VOCs, or less than or equal to about 25% by weight VOCs, or less than or equal to about 20% by weight VOCs, or less than or equal to about 15% by weight VOCs, or less than or equal to about 10% by weight VOCs. The VOC level may be from about 0.05 wt. % to about 35 wt. %, or from about 2 wt. % to 20 wt. %.

### Active Ingredients

The pest control composition may comprise one or more active ingredients (also referred to herein as actives). The pest control composition may comprise from about 0.005% to about 15%, or from about 0.05% to about 12%, or from about 0.15% to about 10%, or from about 0.5% to about 8%, or from about 1% to about 6%, by weight of the composition of one or more active ingredients.

Nonlimiting examples of active ingredients include aldehyde C16 (pure), almond oil, terpenes, alpha-terpineol, verbenone, alpha-cedrene, cinnamic aldehyde, amyl cinnamic aldehyde, cinnamyl acetate, amyl salicylate, anisic aldehyde, cedrol, benzyl alcohol, benzyl acetate, cinnamaldehyde, cinnamic alcohol, carvacrol, caryophyllene, carveol, citral, citronellal, methylheptenone, citronellol, dimethyl salicylate, eucalyptol (also known as 1,8-cineole), thujopsene, 3-thujopsanone, α-thujone, β-thujone, fenchone, eugenyl acetate (e.g., isocugenyl acetate), eugenol, iso-eugenol, methyl iso-eugenol, galaxolide, geraniol, guaiadiene, guaiacol, ionone, menthol (e.g., L-menthol), menthyl ester, menthone, carvone (e.g., L-carvone), camphor, camphene, p-cymene, borncol, bornyl esters, bornyl acetate, isobornyl acetate, terpinene (e.g., gamma-terpinene), methyl anthranilate, methyl ionone, methyl salicylate, nerol, phellandrene (e.g., alpha-phellandrene), pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, myrcene, chavicol, acetaldehyde, safrole, terpinen-4-ol, cineole, dimethyl trisulfide, diallyl disulfide, diallyl sulfide, diallyl tetrasulfide, 3-vinyl-[4H]-1,2-dithiin, thyme oil, thyme oil white, thyme oil red, thymol, anethole (e.g., trans-anethole), vanillin, ethyl vanillin, castor oil, cedar oil, cedarwood oil, cinnamon, cinnamon oil, citronella, citronella oil, clove, clove oil, corn oil, corn mint oil, oregano oil, cottonseed oil, garlic, garlic oil, geranium oil, lemongrass oil, linseed oil, mint, mint oil, peppermint, peppermint oil, spearmint, rose oil, spearmint oil, rosemary, rosemary oil, sesame, sesame oil, soybean oil, white pepper, licorice oil, wintergreen oil, anise oil (e.g., star anise oil), lilac flower oil, black seed oil, bay oil, grapefruit seed oil, grapefruit, lemon oil, orange oil, orange flower oil, tea tree oil, cedar leaf oil, camphor oil, Tagete minuta oil, lavender oil, Lippia javancia oil, oil of bergamot, galbanum oil, eucalyptus oil, lovage oil, and mixtures thereof.

The pest control composition may comprise about 0.005% to about 15%, or from about 0.05% to about 15%, or from about 0.15% to about 12%, or from about 0.5% to about 10% by weight of the composition of one or more active ingredients chosen from eugenol, 2-phenylethyl propionate, menthol, menthone, amyl butyrate, geraniol, limonene (e.g., d-limonene), p-cymene, linalool, linalyl acetate, camphor, methyl salicylate, pinene (e.g., alpha-pinene, beta-pinene), eucalyptol, piperonal, piperonyl alcohol, tetrahydrolinalool, thymol, carvone (e.g., L-carvone), vanillin, ethyl vanillin, iso-eugenol, bornyl acetate, isobornyl acetate, terpinene (e.g., gamma-terpinene), cinnamyl acetate, cinnamic alcohol, cinnamaldehyde, ethyl cinnamate, pyrethrins, abamectin, azadirachtin, amitraz, rotenone, boric acid, spinosad, biopesticides, synthetic pesticides, or mixtures thereof.

The pest control composition may comprise one or more synthetic pesticides. Nonlimiting examples of synthetic pesticides include pyrethroids, such as bifenthrin, esfenvalerate, fenpropathrin, permethrin, cypermethrin, cyfluthrin, deltamethrin, allethrin, lambda-cyhalothrin, or the like; synergists, such as piperonyl butoxide, or the like; juvenile hormone analogues, such as methoprene, hydroprene, kinoprene, or the like; and neonicotinoids, such as imidacloprid, acetamiprid, thiamethoxam, or the like, and mixtures thereof. The pest control composition may comprise less than about 10%, or less than about 5%, or less than about 2%, or less than about 1%, or less than about 0.5%, or less than about 0.1% by weight of the composition of a synthetic pesticide. Alternatively, the pest control composition may be substantially free of a synthetic pesticide.

The pest control composition may comprise one or more biopesticides. Nonlimiting examples of biopesticides include pyrethrum, rotenone, neem oil, and mixtures thereof.

The pest control composition may comprise from about 0.15% to about 15%, or from about 0.5% to about 12%, or from about 1% to about 15%, or from about 0.5% to about 10%, by weight of the composition of one or more active ingredients, where the active ingredient is an essential plant oil. The pest control composition may comprise one or more essential plant oils selected from the group consisting of corn mint oil, peppermint oil, spearmint oil, rosemary oil, thyme oil, citronella oil, clove oil, cinnamon oil, cedarwood oil, garlic oil, geranium oil, lemongrass oil, and mixtures thereof, preferably selected from the group consisting of corn mint oil, spearmint oil, rosemary oil, thyme oil, and mixtures thereof, more preferably selected from the group consisting of corn mint oil, rosemary oil, and combinations thereof. In some aspects, the pest control composition may comprise from about 1% to about 15% by weight of the composition of an active ingredient chosen from geraniol, cornmint oil, lemongrass oil, rosemary oil, or mixtures thereof.

In some aspects, the pest control composition may comprise from about 0.5% to about 10% by weight of the composition of geraniol and/or from about 0.5% to about 5% by weight of the composition of cornmint oil.

### pH Adjusting Agents

In some aspects, the pest control compositions described herein may comprise from about 0.00001% to about 1.5%, or from about 0.0001% to about 1%, or from about 0.001% to about 0.8%, or from about 0.01% to about 0.6%, by weight of the composition of a pH adjusting agent. In some aspects, the pest control compositions described herein may comprise from about 0.00001% to about 5%, or from about 0.0001% to about 2%, or from about 0.001% to about 01%, by weight of the composition of a pH adjusting agent. Non-limiting examples of pH adjusting agents include a carboxylic acid or a salt thereof chosen from citric acid or a salt thereof, malic acid or a salt thereof, acetic acid or a salt thereof, fumaric acid or a salt thereof, humic acid or a salt thereof, or mixtures thereof, preferably citric acid or a salt thereof, more preferably citric acid anhydrous or citric acid monohydrate. The compositions described herein may comprise from about 0.00001% to about 1.5% by weight of the composition of citric acid or a salt thereof, such as sodium citrate, monosodium citrate, disodium citrate, trisodium citrate, trisodium citrate dihydrate, potassium citrate, monopotassium citrate, tripotassium citrate, tripotassium citrate monohydrate, or dipotassium citrate. Carboxylic acids, such as citric acid, or salts thereof may function to adjust the pH of the composition and/or as a chelant.

### Surfactant

The pest control composition disclosed herein may be formulated with one or more surfactants. The pest control composition may comprise from about 0.01% to about 15%, or from about 0.1% to about 12%, or from about 1% to about 10%, or from about 1% to about 8% by weight of the composition of one or more surfactants, preferably one or more anionic surfactants, more preferably sodium lauryl sulfate. In some aspects, the pest control composition may comprise from about 0.2% to about 10%, or from about 1% to about 8%, by weight of the composition of one or more surfactants.

A sprayed drop of a pesticidal composition comprising an active agent is preferably able to wet a target surface and spread out or cover a target area to perform its intended function. A surfactant generally reduces the surface tension of the water on the surface of the spray drop by reducing the interfacial tension between the spray drop and target surface, e.g., exoskeleton of an arthropod. Surfactants also wet and disperse particles of active ingredient(s) in the composition prior to spraying, thereby enabling more uniform coverage and wetting of the target arthropod upon spraying. Surfactants may also function to emulsify active agents that are not easily solubilized in water, such as oils. Surfactants may also function to create and stabilize a foam by reducing the interfacial tension between air and the liquid composition. Surfactants thus include various agents known to function as emulsifiers or wetting agents. Suitable surfactants include anionic surfactants, amphoteric surfactants, zwitterionic surfactants, nonionic surfactants, cationic surfactants, or mixtures thereof.

Anionic surfactants are surfactant compounds that contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants. Anionic surfactants include the alkali metal, ammonium and alkanol ammonium salts of organic sulfuric reaction products having in their molecular structure an alkyl or alkaryl group containing from about 8 to about 22 carbon atoms and a sulfonic or sulfuric acid ester group. Examples of such anionic surfactants include water soluble salts and mixtures of salts of alkyl benzene sulfonates having from about 8 to about 22 carbon atoms in the alkyl group (e.g., linear alkyl benzene sulfonates, such as dodecylbenzene sulfonate and salts thereof), alkyl sulfates and alkali metal salts thereof (preferably those having from about 8 to about 22 carbon atoms in the alkyl group, e.g., sodium dodecyl/lauryl sulfate), alkyl ether sulfates having from about 8 to about 22 carbon atoms in the alkyl group and about 2 to about 9 moles of ethylene oxide. Aryl groups generally include one or two rings, alkyl groups generally include from about 8 to about 22 carbon atoms, and ether groups generally comprise from about 1 to about 9 moles of ethylene oxide (EO) and/or propylene oxide (PO), preferably EO. A preferred anionic surfactant is sodium lauryl sulfate or SLS (also known as sodium dodecyl sulfate). The pest control composition may comprise from about 0.2% to about 10%, preferably from about 2% to about 8.5%, or from about 4% to about 8%, by weight of the composition of sodium lauryl sulfate.

Anionic surfactants may also include fatty acids and salts thereof. Fatty acids and salts thereof are organic molecules comprising a single carboxylic acid moiety (carboxylate anion in salts) and at least 7 carbon atoms, or from about 11 to about 22 carbon atoms, or from about 12 to about 16 carbon atoms. The salts may be sodium, potassium, calcium, magnesium, barium, iron, ammonium and amine salts of fatty acids. The salts of fatty acids are also known as soaps. Fatty acid and the salts thereof may be linear, branched, saturated, unsaturated, cyclic, or mixtures thereof. Nonlimiting examples of fatty acids and salts thereof include octanoic acid, nonanoic acid, decanoic acid, lauric acid, myristic acid, palmitic acid, stearic acid, arachidic acid, behenic acid, lignoceric acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, the sodium, calcium, potassium or zinc salts thereof, or mixtures thereof.

Alternatively, the compositions may be substantially free of fatty acids, as a fatty acid may be difficult to solubilize in an aqueous composition. In particular, the compositions may be substantially free of lauric acid, oleic acid, stearic acid, or a combination thereof.

Additional suitable anionic surfactants include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, acyl methyl taurates, sulfoacetates, acyl lactates, and sulfosuccinamides.

Amphoteric surfactants are surface active agents containing at least one anionic group and at least one cationic group and may act as either acids or bases, depending on pH. Some of these compounds are aliphatic derivatives of heterocyclic secondary and tertiary amines, in which the aliphatic substituent(s) may be straight or branched, at least one of the aliphatic substituents contains from about 6 to about 20, or from about 8 to about 18, carbon atoms, and at least one of the aliphatic substituents contains an anionic water-solubilizing group, e.g., carboxy, phosphonate, phosphate, sulfonate, sulfate.

Zwitterionic surfactants are surface active agents having a positive and negative charge in the same molecule, where the molecule is zwitterionic at all pHs. Zwitterionic surfactants include betaines and sultaines. The zwitterionic surfactants generally contain a quaternary ammonium, quaternary phosphonium, or a tertiary sulfonium moiety. Zwitterionic surfactants contain at least one straight chain or branched aliphatic substituent, which contains from about 6 to 20, or from about 8 to about 18, carbon atoms, and at least one aliphatic substituent containing an anionic water-solubilizing group, e.g., carboxy, sulfonate, sulfate, phosphate or phosphonate.

Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates, where the alkyl group has from 6 to about 20 carbon atoms. Other suitable amphoteric and zwitterionic surfactants include alkyliminomonoacetates, alkyliminidiacetates, alkyliminopropionates, alkyliminidipropionates, and alkylamphopropylsulfonates, where the alkyl group has from about 12 to about 18 carbon atoms, as well as alkyl betaines, alkylamidoalkylene betaines, alklyl sultaines, and alkylamidoalkylenchydroxy sulfonates.

The nonionic surfactant(s) may be any of the known nonionic surfactants, examples of which include condensates of ethylene oxide with a hydrophobic moiety. Nonionic surfactants include ethoxylated primary or secondary aliphatic alcohols having from about 8 to about 24 carbon atoms, in either straight or branch chain configuration, with from about 2 to about 40, or from about 2 and about 9 moles of ethylene oxide per mole of alcohol. Other suitable nonionic surfactants include the condensation products of alkyl phenols having from about 6 to about 12 carbon atoms with about 3 to about 100, or 3 to about 60, or 3 to about 30, or about 5 to about 14 moles of ethylene oxide. Nonionic surfactants also include ethoxylated castor oils and silicone surfactants, such as Silwet L-8610, Silwet L-8600, Silwet L-77, Silwet L-7657, Silwet L-7650, Silwet L-7607, Silwet L-7604, Silwet L-7600, and Silwet L-7280. Nonionic surfactants also include polyglyceryl oleate/stearate.

The pest control compositions of the present disclosure may optionally comprise one or more cationic surfactants. Suitable cationic surfactants include quaternary ammonium surfactants and amino surfactants that are positively charged at the pH of the pest control composition.

The weight ratio of surfactant, preferably anionic surfactant, more preferably sodium lauryl sulfate, to active ingredient is from about 1:3 to about 30:1, or about 1:3 to about 20:1, or about 1:1 to about 20:1, or about 1:1 to about 10:1, or about 1:3 to about 3:1, or about 1:2 to about 2:1, or about 1:1.5 to about 1.5:1, or about 1:1.2 to about 1.2:1. The weight ratio of surfactant, preferably anionic surfactant, more preferably sodium lauryl sulfate, to active ingredient, preferably an essential oil or a constituent thereof, may be from about 1:1 to about 30:1 or about 1:1 to about 20:1.

### Solvent

The pest control compositions described herein may comprise from about 0.05% to about 45%, or from about 1% to about 35%, or from about 1.5% to about 25%, or from about 2% to about 20% by weight the composition of one or more solvents. Liquid pest control compositions may contain one or more solvents. In some aspects, the pest control composition may comprise from about 2.5% to about 25% by weight of the composition of a first solvent such as isopropyl alcohol. In some aspects, the pest control composition may further comprise from about 0.1% to about 10% by weight of the composition of a second solvent, wherein the second solvent is chosen from triethyl citrate, isopropyl myristate, propylene carbonate, ethyl lactate, butyl lactate, butyl stearate, glycerin, urea, or mixtures thereof. In some aspects, the pest control composition may comprise from about 0.1% to about 5% by weight of the composition of a second solvent, wherein the second solvent is glycerin.

Suitable solvents include alcohols, such as monohydridic or polyhydridic alcohols. Preferred alcohols are low molecular weight primary or secondary alcohols exemplified by ethanol, propanol, and isopropanol, preferably isopropanol. Monohydric alcohols and polyols, such as those containing from 2 to about 6 carbon atoms and from 2 to about 6 hydroxy groups (e.g., ethylene glycol, glycerine, and 1,2-propanediol (also referred to as propylene glycol)), may also be used.

Suitable solvents may include urea. The pest control compositions may comprise from about 0.1% to about 10%, or from about 0.5% to about 10%, or from about 0.5% to about 8%, or from about 1% to about 6%, by weight of the composition of urea. Without wishing to be bound by theory, urea may improve the stability, availability, and/or solubility of the one or more active ingredients in the composition, thereby improving the efficacy of the composition without increasing the concentration of VOCs. Further, urea may improve the low temperature stability of compositions containing anionic surfactants, such as SLS.

Suitable solvents may also include esters. The pest control composition may comprise from about 0.005% to about 15%, or from about 0.05% to about 12%, or from about 0.5% to about 10%, or from about 1% to about 7%, by weight of the composition, of one or more esters. Esters are commonly formed by reacting a carboxylic acid with a molecule comprising one or more hydroxyl groups. Examples of suitable carboxylic acids include acetic acid, formic acid, lactic acid, citric acid, malic acid, oxalic acid, propanoic acid, propiolic acid, butyric acid, isobutryic acid, caproic acid, adipic acid, benzoic acid, salicylic acid, caprylic acid and fatty acids. Nonlimiting examples of molecules comprising one or more hydroxyl groups include methanol, ethanol, sorbitol, propyl alcohol, isopropyl alcohol, butyl alcohol, sec-butyl alcohol, isobutyl alcohol, tert-butyl alcohol, ethylene glycol, propylene glycol, glycerol, polyglycerol, cyclohexanol, and benzyl alcohol. Examples of suitable esters include isopropyl myristate, myristyl myristate, isopropyl palmitate, octyl palmitate, isopropyl isothermal, butyl lactate, ethyl lactate, butyl stearate, triethyl citrate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, decyl oleate, glyceryl stearate, isocetyl stearate, octyl stearate, putty stearate, isostearyl neopentonate, polypropylene glycol (PPG) myristyl propionate, diglyceryl monooleate, and diglyceryl monostearate. The pest control composition may comprise ethyl lactate, or from about 0.005% to about 15%, or from about 0.05% to about 12%, or from about 0.5% to about 10%, or from about 1% to about 7%, by weight of the composition of ethyl lactate.

Additional solvents include lipophilic fluids, including siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, and mixtures thereof.

Suitable solvents listed under section 25 (b) of the Federal Insecticide, Fungicide, and Rodenticide Act (FIFRA) include butyl lactate (including enantiomers thereof), vinegar, 1,2-propylene carbonate, isopropyl myristate, ethyl lactate (including enantiomers thereof), and glycerin.

Preferred solvents include isopropanol, ethanol, glycerin, ethyl lactate, renewable versions thereof, and mixtures thereof. The pest control compositions described herein may comprise from about 0.05% to about 45%, or from about 0.5% to about 30%, or from about 1% to about 25%, or from about 1.5% to about 20, or from about 2 to about 15% by weight of the composition of a solvent chosen from of isopropanol, glycerin, or mixtures thereof.

Without being bound to theory, it is believed that certain solvents may affect the properties of the pest control foam that is generated by a foaming dispenser. For example, it is believed that isopropanol may affect certain foam properties and that the concentration of isopropanol may be selected to optimize these foam properties.

Without being bound to theory, it is also believed that the weight ratio of surfactant to solvent may affect certain foam properties and the weight ratio of surfactant to solvent may be selected to optimize these foam properties. The weight ratio of surfactant to solvent may range from about 2:1 to about 1:5, or from about 1.2:1 to about 1:4, or from about 1:1 to about 1:4, or from about 1:1 to about 1:3. The pest control composition may comprise sodium lauryl sulfate and isopropanol, where the weight ratio of sodium lauryl sulfate to isopropanol may be from about 2:1 to about 1:5, or from about 1.2:1 to about 1:4, or from about 1:1 to about 1:3. In some aspects, the weight ratio of sodium lauryl sulfate to isopropanol may be from about 2:1 to about 1:12, or from about 1.5 to about 1:4.

### Preservatives

The pest control compositions disclosed herein may comprise one or more preservatives. As used herein a “preservative” is any substance or compound that is added to protect against decay, decomposition, or spoilage. Preservatives may be natural or synthetic. Preservatives may be antimicrobial preservatives, which inhibit the growth of bacteria or fungi, including mold, or antioxidants. Nonlimiting examples of preservatives include potassium sorbate, sodium benzoate, tocopherol (e.g., tocopherol acetate), calcium propionate, sodium nitrate, sodium nitrite, sulfites (sulfur dioxide, sodium bisulfite, potassium hydrogen sulfite, etc.), and disodium EDTA. The pest control compositions disclosed herein may comprise from about 0.02% to about 10% by weight of the composition of a preservative, or from about 0.05% to about 8%, or from about 0.5% to about 6%. Non-limiting examples of preservatives can include potassium sorbate, tocopherol, or mixtures thereof.

### Dye

The pest control composition may comprise a dye or colorant. Nonlimiting examples of colorants include inorganic pigments, such as ultramarine blue, organic dyes, and trace nutrients, such as salts of iron, manganese, boron, copper, cobalt, molybdenum and zinc. Colorants may be included to modify the aesthetics of the pest control compositions. The compositions disclosed herein may comprise from about 0.001% to about 0.1%, or 0.005% to about 0.05%, or 0.008% to about 0.02%, by weight of the composition of a dye or colorant. Alternatively, the pest control composition may be substantially free of a dye or colorant.

### Anti-foam

The pest control compositions disclosed herein may be substantially free of anti-foam agents, such as silicone antifoam agents, alcohol antifoam agents, and paraffin antifoam agents, such as those disclosed in US Patent Publication No. 2023/0025485A1.

### Dispensing and Packaging

The foaming pest control compositions may be dispensed using any number of suitable foam dispensers, including mechanical foam dispensers and aerosol foam dispensers. Suitable mechanical foam dispensers can include squeeze foam dispensers, pump foam dispensers, other mechanical foam dispensers, or combinations thereof. The mechanical foam dispenser may be a squeeze foam dispenser. Non-limiting examples of suitable pump foam dispensers include those described in WO 2004/078903, WO 2004/078901, and WO 2005/078063, and may be supplied by Albea (60 Electric Ave., Thomaston, Conn. 06787 USA) or Rieke Packaging Systems (500 West Seventh St., Auburn, Ind. 46706).

A mechanical foam dispenser may be attached to a container or reservoir for holding the pest control composition. The reservoir may comprise a material including, but not limited to, plastic, paper, cardboard, metal, alloy, laminate, and combinations thereof. The reservoir may be a refillable reservoir, such as a pour-in or screw-on reservoir, or the reservoir may be for one-time use. The reservoir may be removable from the mechanical foam dispenser or the reservoir may be integrated with the mechanical foam dispenser. The mechanical foam dispenser may comprise two or more reservoirs. The reservoir may be comprised of a material chosen from rigid materials, flexible materials, or combinations thereof. The reservoir may be comprised of a rigid material, which preferably does not collapse under external atmospheric pressure when subjected to an interior partial vacuum.

Similarly, an aerosol dispenser or aerosol foam dispenser may be attached to a container or reservoir for holding the pest control composition. The reservoir may comprise a material including, but not limited to, plastic, paper, cardboard, metal, alloy, laminate, and combinations thereof. The reservoir may be for one-time use or refillable. The reservoir may be removable from the aerosol foam dispenser or integrated with the aerosol foam dispenser. The aerosol foam dispenser may comprise two or more reservoirs. The reservoir may be comprised of a material chosen from rigid materials, flexible materials, or combinations thereof. The reservoir may be comprised of a rigid material, which preferably does not collapse under external atmospheric pressure when subjected to an interior partial vacuum.

The aerosol reservoir may comprise a propellant. Examples of suitable propellants may include compressed gasses, such as nitrogen, carbon dioxide, and air; liquidized hydrocarbons, such as butane, isobutate, and propane; hydrofluoro-olefins, and mixtures thereof. The propellant may be selected from the group consisting of nitrogen, carbon dioxide, and mixtures thereof. In some aspects, the aerosol reservoir may be substantially free of liquidized hydrocarbons. The aerosol container may have an internal gauge pressure of from about 414 kPa to about 1,100 kPa, or from about 600 kPa to about 1,000 kPa, or from about 700 kPa to about 900 kPa.

The foam dispenser may comprise a flow path comprising a vent to allow atmospheric air into the foam dispenser. In some aspects, the foam dispenser may further comprise a mesh or screen comprising a material such as nylon, polypropylene, metal, polyethylene, and the like.

The pest control compositions described herein may be packaged in a transparent or translucent container or reservoir. The transparent or translucent container or reservoir may have a light transmittance of greater than 25% at wavelength of about 410-800 nm. Container and/or reservoir materials that may be used include, but are not limited to, polypropylene (PP), polyethylene (PE), polycarbonate (PC), polyamides (PA) and/or polyethylene terephthalate (PETE), polyvinylchloride (PVC); and polystyrene (PS).

The transparent container or reservoir may have a transmittance of more than about 25%, or more than about 30%, or more than about 40%, or more than about 50% in the visible part of the spectrum (approx. 410-800 nm). Alternatively, absorbency of the container or reservoir may be measured as less than about 0.6 or by having transmittance greater than about

$$\frac{1}{{10}^{absorbancy}} \times 100 \%$$

25%, where % transmittance equals:

For purposes of the disclosure, as long as one wavelength in the visible light range has greater than about 25% transmittance, it is considered to be transparent/translucent.

### Test Methods

Determination of the Hunter L.a.b. (CIE) b*Value

The formation of yellow color is measured using the Hunter L.a.b. (CIE) method. The b value is determined using a HunterLab ColorFlex EZ® spectrophotometer (HunterLab, 11491 Sunset Hills Road, Reston, Virginia 20190). The methodology that is used is described in detail in the “User's Manual for ColorFlex EZ Version 2.2.” The average of four separate readings is reported.

The HunterLab ColorFlex EZ® spectrophotometer uses a xenon flash lamp to illuminate a sample. The light reflected from the sample is then separated into its component wavelengths through a dispersion grating. The relative intensities of the light at different wavelengths along the visible spectrum (400-700 nm) are then analyzed to produce a number result indicative of the color of the sample.

### Turbidity

A turbidimeter is used to measure the turbidity of pesticidal compositions. This instrument measures the turbidity of liquids in Nephelometric Turbidity Units (NTU). The method of measuring turbidity is described in detail in the following reference: Hach 2100Q and 2100 Qis User Manual, Edition 6, 08/2021, from the Hach Company.

This method of measurement determines quantitative values of turbidity by evaluating the ratio of a primary nephelometric light scatter signal to a transmitted light scatter signal. This particular method of evaluation provides values between 0-1000 NTU, where increasing NTU values indicate more turbid compositions. In between each test sample, water controls may be measured to ensure proper equipment operation. For example, water may have a turbidity of about 1.11 NTU and isopropyl alcohol may have a turbidity of about 0.15 NTU. It is believed that improved emulsification of active ingredients, particularly hydrophobic active ingredients, yields lower NTU values.

### Stability

Place the sample formulation in a suitable container, such as a sealed glass jar or equivalent, and store at 25° C. for 24 hours. Then assess the sample formulation visually for the number of phases. A stable formulation contains a single phase.

### Specific Volume Method

Specific volume is measured by dispensing three trigger pulls or a three second aerosol spray of test product into a 500 mL graduated cylinder. The initial volume after being sprayed is recorded in mL. The mass of product dispensed is measured by subtracting the initial weight of the cylinder before dispensing product from the weight of the cylinder after product has been dispensed in units of grams. The volume determined above is divided by the mass of product dispensed to determine the specific gravity in units of mL/g. All measurements are performed in a laboratory maintained at 23° C. ±2 C.° and 50% ±2% relative humidity and test products are conditioned in this environment for at least 2 hours prior to testing.

### Foam Collapse Test Method

The foam collapse test method measures the foam height versus time of a test sample over 135 seconds using a foam analyzer. A suitable foam analyzer instrument is the Kruss DFA 100 Foam Analyzer, or equivalent. Suitable materials for the instrument set up include the following, or equivalents: (i) Kruss DFA 100 Foam Analyzer; (ii) SH4501-sparging column holder; (iii) Sparging air methodology; (iv) CY4572-Prism column (40 mm) with calibration grid for foam structure analyses; (v) FL4503-glass filter plates; (vi) 100 mL graduated cylinder; (vii) ME4510-Liquid content electrodes; (viii) Paper towels; and (ix) Water-Deionized water. All measurements are performed in a laboratory maintained at 23° C. ±2 C.° and 50% ±2% relative humidity and test samples are conditioned in this environment for at least 2 hours prior to testing.

The instrument setup is described in the following steps: (i) Set camera height to 80 mm (camera is part of the Kruss DFA 100 Foam Analyzer); (ii) Set height illumination-A=469 nm; (iii) Set camera distance at ‘position 3’; (iv) Adjust camera focus to 1.4; (v) Insert the SH4501 sparging head onto the column holder; (vi) Place the FI4531 O-ring on top of filter FL4503 and one on bottom to create a water tight seal between the column holder and the column; (vii) Insert the ME4510 electrodes into the column and align with the top FI4531 O ring; (viii) Insert the assembled SH4501 column holder into the Kruss DFA 100 Foam Analyzer; (ix) Ensure the CY4572 prism column is accurately aligned straight towards the instrument; and (x) View ‘Live camera’ from analysis software (analysis software comes together with the Kruss DFA 100 Foam Analyzer) to ensure camera is capturing unobstructed full view of the CY4572 prism column surface.

Measure 75 mL of the test sample in a 100 mL graduated cylinder. Gently pour the measured test sample into the prism column to minimize bubble generation.

The analysis software program setup is described in the following steps: (i) Check mark detection boxes containing height and structure program selection (ii) Set live view and controls to Illumination height set to 12%, structure illumination set to 20%, flow rate set to 0.3 L/min, data sampling rates foaming height to 5 frames per second (fps), structure 2 fps, decay height 5 fps, structure 2 fps; (iii) Set automation program to start foaming at 0 seconds; (iv) Set automation program to stop foaming at 15 seconds; (v) Set automation program to stop measuring at 135 seconds; (vi) Initiate testing.

### Data Analysis and Interpretation

Graphs depicting time (seconds) versus foam height (mm) are constructed. The foam collapse rate is defined as the linear curve fit of foam height as a function of time from 50 seconds to 135 seconds. The slope of the line is recorded for the test sample. In like fashion, repeat for a total of four replicate test samples. Calculate the average of the slope and report as Foam Collapse Rate to the nearest 0.01 mm/sec. Foam collapse rate helps determine how quickly foam dissipates according to the method above. A higher slope value indicates a quicker collapse time. The foam height at 15 seconds is recorded as plateau height to the nearest 1 mm. The time at which the foam height begins to decrease is recorded as the plateau time to the nearest 0.1 sec. The average plateau height and plateau time among the four replicate test samples is calculated and reported as Plateau Height to the nearest 1 mm and Plateau Time to the nearest 0.1 sec.

### Foam Lather Test Method

Foam properties of a test sample can be measured by means of the foam creaminess and/or the foam stability of a test sample. All measurements are performed in a laboratory maintained at 23° C. ±2 C.° and 50%±2% relative humidity and test samples are conditioned in this environment for at least 2 hours prior to testing. Foam properties of a test sample are measured using a foam analyzer instrument (such as Kruss DFA 100 Foam Analyzer, or equivalent). Suitable materials for the instrument set up include the following, or equivalents (i) Kruss DFA 100 Foam Analyzer; (ii) SH4511-sparging column holder; (iii) Sparging air methodology; (iv) CY4572-Prism column (40 mm) with calibration grid for foam structure analyses; (v) FL4533-glass filter plates in stainless steel sockets; (vi) syringe; (vii) NE4511—Dosing needle for column filling; (viii) Paper towels; and (ix) Water-Deionized water.

The instrument setup is described in the following steps: (i) Set camera height to 116 mm (camera is part of the Kruss DFA 100 Foam Analyzer); (ii) Set height illumination−λ=469 nm; (iii) Set camera distance at ‘position 2’; (iv) Adjust camera focus to 1.4; (v) Place a FI4531 O-ring in the bottom of the SH4511 sparging base, then place the FL4533 filter in with another O-ring on top to create a water tight seal between the column holder and the column; (vi) Align the CY4572 column in the SH4511 sparging base; (vii) Insert the assembled SH4511 column holder into the Kruss DFA 100 Foam Analyzer; (viii) Ensure the CY4572 prism column is accurately aligned straight towards the instrument; and (x) View ‘Live camera’ from analysis software (analysis software comes together with the Kruss DFA 100 Foam Analyzer) to ensure camera is capturing unobstructed full view of the CY4572 prism column surface.

Measure 85 mL of the test sample with the syringe with the dosing needs attached. Then gently dispense the test sample into the prism column to minimize bubble generation.

The analysis software program setup is described in the following steps: (i) Check mark detection boxes containing height and structure program selection; (ii) Set live view and controls to Illumination height set to 12%, structure illumination set to 20%, flow rate set to 0.3 L/min, data sampling rates foaming height to 5 frames per second (fps), structure 2 fps, decay height 5 fps, structure 2 fps; (iii) Set automation program to start foaming at 0 seconds; (iv) Set automation program to stop foaming at 15 seconds; (v) Set automation program stop measuring at 135 seconds; (vi) Initiate testing.

### Data Analysis and Interpretation

Graphs depicting time (seconds) versus foam height (mm) are constructed. The foam decay rate is defined as the linear curve fit of foam height as a function of time from 50 seconds to 135 seconds. The slope of the line is recorded for the test sample. In like fashion, repeat for a total of four replicate test samples. Calculate the average of the slope and report as Foam Collapse Rate to the nearest 0.01 mm/sec.

The following outputs are generated from the analysis software on the foam analyzer instrument: 25% liquid drainage time (sec), drainage half-life time (sec), max foam volume (mL), initial bubble count (mm⁻²), final bubble count (mm⁻²), initial average bubble radius (μm), final average bubble radius (μm), initial sauter mean radius (μm), and final sauter mean radius (μm). For the purposes herein, initial bubble count is defined as the bubble count at 15 seconds and the final bubble count is defined as the bubble count at 135 seconds. For the purposes herein, 25% liquid drainage time is defined as the time it takes for 25% of the Initial Foam Height to collapse into a liquid. Drainage half-life time is the defined as the time it takes for 50% of the Initial Foam Height to collapse to liquid. Initial Foam Height is defined as the foam height at 15 seconds (e.g., immediately after sparging is complete). For the purposes herein, initial average bubble radius is defined as the bubble radius at 15 seconds and the final average bubble radius is defined as the bubble radius at 135 seconds. For the purposes herein, initial sauter mean radius is defined as the sauter mean radius at 15 seconds and the final sauter mean radius is defined as the sauter mean radius at 135 seconds. The average among the four replicate test samples is calculated for each of the recorded parameters and reported as 25% Liquid Drainage Time to the nearest 0.1 sec, Drainage Half-Life Time to the nearest 0.1 sec, Max Foam Volume to the nearest 0.1 mL, Initial Bubble Count to the nearest 0.1 mm⁻², Final Bubble Count to the nearest 0.1 mm⁻², Initial Average Bubble Radius to the nearest 0.1 μm, Final Average Bubble Radius to the nearest 0.1 μm, Initial Sauter Mean Radius to the nearest μm, and Final Sauter Mean Radius to the nearest μm.

Calculate the absolute value of the Final Bubble Count minus the Initial Bubble Count and record as Delta Bubble Count to the nearest 0.1 mm⁻². Calculate the absolute value of the Final Average Bubble Radius minus the Initial Average Bubble Radius and record as Delta Bubble Radius to the nearest 0.1 μm. Calculate the absolute value of Final Sauter Mean Radius minus the Initial Sauter Mean Radius and record as Delta Sauter Mean Radius to the nearest 0.1 μm.

### Particle Size Test Method

Particle size is measured by light scattering data techniques. Particle size is determined with a Malvern Zetasizer Nano ZSP (Malvern Panalytical, Malvern, United Kingdom), or the like. The software used for control of the instrument and for data acquisition is the Malvern Zetasizer Software version 8.01.4906 (Malvern Panalytical). All samples are kept at 25° C., unless otherwise specified.

Samples are measured in BRAND® polystyrene disposable cuvettes (Cat. No. 759070D or equivalent). 1 mL of the sample is added into the cuvette using a disposable transfer pipette (VWR, Cat. No. 414004-004 or equivalent), swirled, and then discarded. Another 1 mL of the sample is added into the cuvette using a disposable transfer pipette. The cap is placed on the cuvette and all sides of the cuvette are wiped with lint-free lens paper. The cuvette is loaded into the instrument in accordance with the manufacture's specification to ensure light is passing correctly into the sample during the measurement, and the lid is closed.

The instrument is readied in accordance with manufacture's specification. The particle size measurements are made through the software with the following settings:
1) Under the ‘Measure’ section, the ‘Manual’ option is selected. ‘Measurement Type’ is then set to ‘Size’.
2) The ‘Sample’ section is then selected. In the ‘Material’ subsection: ‘Material’ is chosen to be ‘SDS’; the ‘RI’ is set to 1.461; and the ‘Absorption’ is set to 0.001. In the ‘Dispersant’ subsection: ‘Dispersant’ is selected as ‘Water’; ‘Temperature’ is set to 25.0 deg C; ‘Viscosity’ is set at 0.8872 cP; and ‘RI’ is set as 1.330. In the ‘General options’ subsection ‘Mark-Houwink Parameters’ is selected, ‘A Parameter’ is set to 0.428; and ‘K Parameter (cm2/s)’ is set to 7.67e-05. In the ‘Temperature’ subsection: ‘Temperature’ is set as 25.0 deg C; ‘Equilibration Time (second)’ is set to 120. In the ‘Cell’ subsection: ‘Cell Type’ is selected to be ‘Disposable cuvettes’; and the ‘DTS0012’ option is selected.
3) The ‘Measurement’ section is then selected. The ‘Angle of Detection Measurement Angle’ is selected as ‘1730 Backscatter (NIBS default)’; ‘Measurement Duration’ is selected as ‘Automatic’; ‘Number of Runs’ is set to 11; ‘Run duration (seconds)’ is set to 10; ‘Number of Measurements’ is set as 3; ‘Delay between Measurements (seconds)’ is set to 0; ‘Append Measurement Number to Sample Name’ is selected; and ‘Allow Results to be Saved Containing Correlation Data Only’ is not selected. In the ‘Advanced’ subsection: ‘Measurement duration, Extend Duration for Large Part’ is set to ‘No’; ‘Measurement settings, Positioning method’ is set to ‘Seek for Optimum Position’; and Automatic attenuation selection is set to ‘Yes’.
4) The ‘Data Processing’ section is then selected, and the following options are selected: ‘Analysis Model’ is selected as ‘General Purpose (Normal Resolution)’. The ‘Size Analysis Parameters’ are set to: ‘Analysis Details’; ‘Name’ is set to ‘Customized’, ‘Description’ is set to ‘Customized Analysis’; ‘Display Range’ is set with the ‘Lower Limit’ set to 0.6 and ‘Upper Limit’ set to 6000; ‘Multimodal-analysis, Resolution’ is selected to ‘Normal’; ‘Size classes, Number of size classes’ is set as 70; ‘Lower Size Limit’ is set as 0.4; ‘Upper Size Limit’ is set as 10,000; ‘Lower Threshold’ is set as 0.05; and ‘Upper Threshold’ is set as 0.01. In the ‘Reports’ subsection: ‘Print Report’ is not selected and in the ‘Export’ subsection: ‘Export’ results is not selected.

### EXAMPLES

The following data and examples, including comparative examples, are provided to help illustrate pest control compositions described herein. The exemplified compositions are given solely for the purpose of illustration and are not to be construed as limitations of the present invention, as many variations thereof are possible without departing from the spirit and scope of the invention. All parts, percentages, and ratios herein are by weight unless otherwise specified.

### Foam Property Test

Pest control compositions were prepared to assess foam properties of the composition. Examples 1-5 were prepared as described herein according to the formulas in Table 1. Example 5 is a comparative example. Examples 1-5 were evaluated according to the Foam Lather Method as described herein. The results are shown in Table 2.

TABLE 1

| | Ex. 1 | Ex. 2 | Ex. 3 | Ex. 4 | Ex. 5 |
|---|---|---|---|---|---|
| | (wt %) | (wt %) | (wt %) | (wt %) | (wt %) |
| Sodium Lauryl | 6.50 | 6.50 | 5.56 | 1.62 | 0.20 |
| Sulfate (SLS) | | | | | |
| Citric Acid | 0.06 | 0.06 | 0.04 | 0.02 | 0 |
| Isopropyl Alcohol | 16.63 | 16.63 | 4.00 | 16.63 | 10.00 |
| (IPA) | | | | | |
| Glycerin | 0.50 | 2.50 | 0 | 0.50 | 0 |
| Triethyl Citrate | 0 | 0 | 5.56 | 0 | 0 |
| Cornmint Oil¹ | 2.50 | 2.00 | 0.85 | 0.50 | 0.15 |
| Rosemary Oil² | 0 | 0.50 | 0 | 0 | 0 |
| Geraniol³ | 2.50 | 2.50 | 4.14 | 0.75 | 0 |
| Sodium Citrate | 1.00 | 0.92 | 0.25 | 1.00 | 0 |
| Urea | 0 | 0 | 5.00 | 0 | 0 |
| Water | QS | QS | QS | QS | QS |
| SLS:IPA | 1:2.56 | 1:2.56 | 1.39:1 | 1:10.27 | 1:50 |
| Weight Ratio | | | | | |
| SLS:Active | 1.30: 1 | 1.30:1 | 1.11:1 | 1.30:1 | 1.33:1 |
| Weight Ratio | | | | | |

¹Available from Lebermuth (South Bend, IN).
²Available from Ernesto Ventos (Spain).
³Available from Symrise (Germany).

TABLE 2

| | Ex. 1 | Ex. 2 | Ex. 3 | Ex. 4 | Ex. 5 |
|---|---|---|---|---|---|
| Foam Decay Rate (mm/sec) | 0.47 | 0.49 | 0.42 | 0.37 | 0.13 |
| 25% Liquid Drainage Time | 37.2 | 32.6 | 34.2 | 25.2 | 23.3 |
| (sec) | | | | | |
| Drainage Half-Life Time | 53.0 | 43.6 | 43.8 | 39.8 | 30.2 |
| (sec) | | | | | |
| Max Foam Volume (mL) | 146.1 | 155.3 | 160.4 | 159.5 | 164.6 |
| Initial Bubble Count (mm⁻²) | 106.1 | 130.3 | 86.2 | 128.6 | 101.4 |
| Final Bubble Count (mm⁻²) | 76.2 | 78.2 | 50.5 | 69.6 | 72.1 |
| Delta Bubble Count (mm⁻²) | 29.9 | 52.1 | 35.7 | 59.0 | 29.3 |
| Initial Average Bubble | 55.8 | 48.0 | 58.5 | 49.0 | 54.8 |
| Radius (μm) | | | | | |
| Final Average Bubble | 41.0 | 62.0 | 69.8 | 62.0 | 62.5 |
| Radius (μm) | | | | | |
| Delta Bubble Radius (μm) | 14.8 | 14.0 | 11.3 | 13.0 | 7.8 |
| Initial Sauter Mean Radius | 99.3 | 60.8 | 74.0 | 51.8 | 63.8 |
| (μm) | | | | | |
| Final Sauter Mean Radius | 56.0 | 80.5 | 168.3 | 133.3 | 90.3 |
| (μm) | | | | | |
| Delta Sauter Mean Radius | 43.3 | 19.7 | 94.3 | 81.5 | 26.5 |
| (μm) | | | | | |

Through consumer testing, it was found that consumers prefer a foaming pest control composition that sufficiently traps and/or conceals the pest during incapacitation. However, it was found that if the foam persists for too long, it may be less effective at incapacitating the pest (due to low density of the composition) and may be difficult and/or messy for the consumer to clean up.

It was found that Examples 1˜4 can create a foam that initially collapses relatively slowly, as demonstrated by the 25% Liquid Drainage Time of 25.2 seconds or greater and the Drainage Half-Life Time of 39.8 seconds or greater. Examples 1˜4 also exhibit a Foam Decay Rate of 0.37 mm/sec or greater, demonstrating that these foams decay (or collapse) quickly after the pest has been immobilized, allowing the consumer to see that the pest is incapacitated and the composition is easy for a consumer to wipe or clean up. In contrast, it was found that while Example 5 creates a similar volume of foam as compared to Examples 1-4, Example 5 creates a foam that initially collapses relatively quickly, as demonstrated by a 25% Liquid Drainage Time of 23.3 seconds and a Drainage Half-Life Time of 30.2 seconds. It is believed that the foam of Example 5 is too thin and initially collapses too fast to sufficiently trap and/or conceal a pest. It was also found that Example 5 exhibits a Foam Decay Rate of 0.13 mm/sec.

Table 3 is provided for the convenience of the reader. Table 3 includes a non-exhaustive list of properties as well as a non-exhaustive list of corresponding values for each of the properties that pest control composition of the present disclosure may exhibit. There is no requirement that the pest control compositions of the present disclosure exhibit all of these properties.

TABLE 3

| Property | Value |
|---|---|
| Foam Decay Rate (mm/sec) | From about 0.20 to about |
| | 1.0 |
| 25% Liquid Drainage Time (sec) | About 25 to about 50 |
| Drainage Half-Life Time (sec) | About 32 to about 70 |
| Max Foam Volume (mL) | About 130 to about 180 |

Without being limited by theory, it is believed that a pest control composition that exhibits a 25% Drainage of from about 25 seconds to about 50 seconds, a Drainage Half-Life Time of from about 32 seconds to about 70 seconds, and/or a Foam Decay Rate of from about 0.20 mm/sec to about 1.0 mm/sec may create a consumer preferable pest control composition that is applied directly to a pest.

### Scent Intensity Test

A sensory study was performed to understand the scent intensity of foaming and non-foaming spray pest control products. Three qualified expert scent graders evaluated the Products A-D as described in Table 4. The study was conducted in a 7.5 ft×10 ft test room that had no air exchanges under ambient temperature and humidity. The test product was shaken well, and then it was sprayed six times directly on a laminate countertop. The three expert scent graders evaluated the intensity of the scent of the test product using the Scent Intensity Scale (described hereinafter), and they also assessed and recorded the qualitative scent characters. Within the first 0-5 minutes, the peak scent intensity and character were assessed, and the scent intensity score and qualitative scent character assessment were recorded as time =0. The test product was then wiped off the surface. The expert scent graders left the room and returned at specific time points: 1 hour and 4 hours. At each time point, the graders assessed and recorded the scent intensity score and qualitative scent character assessment. In like fashion, the test was repeated for each test product. The average scent intensity score for each test product was calculated and reported as Average Scent Intensity in Table 4. The formulas for the test products are described above in Table 1. The Scent Intensity Scale is as follows:
100=Very Strong Scent
75=Strong Scent
50=Moderate Scent
25=Slight Scent
0=No Detectable Scent

TABLE 4

| | | | Average Scent | | |
|---|---|---|---|---|---|
| | | | Intensity (0-100) | | |
| | | | Time— | Time— | Time— |
| Product | Formula | Delivery | 0 | 1 hour | 4 hours |
| A | Ex. 2 | Non-Foaming Trigger | 63 | 60 | 40 |
| | | Dispenser⁴ | | | |
| B | Ex. 2 | Foaming Trigger | 50 | 50 | 28 |
| | | Dispenser⁵ | | | |
| C | Ex. 3 | Non-Foaming Trigger | 63 | 45 | 33 |
| | | Dispenser⁴ | | | |
| D | Ex. 3 | Foaming Trigger | 38 | 35 | 20 |
| | | Dispenser⁵ | | | |

⁴Mixor MP Trigger Sprayer (1.3CC), commercially available from Silgan Dispensing (Richmond, VA).
⁵TS5 Spray System commercially available from Guala Dispensing (Alessandria, Piemonte, Italy).

It was surprisingly found that formulas that were delivered with a foaming trigger dispenser (Products B and D) exhibited a lower initial Average Scent Intensity and a lower Average Scent Intensity over time as compared to the same formula delivered with a non-foaming trigger dispenser (Products A and C). Through consumer testing, it was found that some consumers prefer a pest control product that has a relatively low scent intensity. Without being limited by theory, it is believed that liquid sprays can create a wide range of particle sizes, including small particles that can remain suspended in the air, resulting in a strong scent perception by the user. By spraying a composition as foam, fewer small droplets may be generated, reducing the airborne scent. Products with a less intense scent may be preferred by some consumers, particularly when the products are intended to be used indoors.

Non-foaming pest control products that utilize essential oils as active ingredients may be limited in the amount of essential oils they can include in order to maintain an acceptable scent intensity for consumers. These constraints on scent intensity may consequently limit the level of efficacy that these products can achieve. It is believed that applying a pest control composition as foam presents an opportunity to overcome these limitations. By utilizing foam delivery, higher levels of essential oils (and thus potentially higher levels of efficacy) may be formulated without the undesirable consequence of an overly strong scent during product use.

### Foam Comparison Test

Example pest control compositions were prepared to assess foam properties as compared to several commercially available compositions. Examples 2 and 6-9 are inventive examples and vary single variably in the concentration of isopropyl alcohol. Example 9 is a comparative example. Examples 2 and 6-9 are prepared as described herein according to the formulas in Table 5. The commercially available compositions are described in Table 6.

Table 6 shows various properties of foams generated from the example pest control compositions and the commercially available compositions, as generated and measured according to the Foam Collapse Test Method described herein.

TABLE 5

| | Ex. 2 | Ex. 6 | Ex. 7 | Ex. 8 | 9 |
|---|---|---|---|---|---|
| | (wt %) | (wt %) | (wt %) | (wt %) | (wt %) |
| Sodium lauryl | 6.50 | 6.50 | 6.50 | 5.60 | 6.50 |
| sulfate (SLS) | | | | | |
| Citric acid | 0.06 | 0.06 | 0.06 | 0.04 | 0.06 |
| Sodium citrate | 0.92 | 0.92 | 0.92 | 0.25 | 0.92 |
| Cornmint Oil¹ | 2.00 | 2.00 | 2.00 | 0.86 | 2.00 |
| Rosemary Oil² | 0.50 | 0.50 | 0.50 | 0.0 | 0.50 |
| Geraniol³ | 2.50 | 2.50 | 2.50 | 4.10 | 2.50 |
| Isopropyl | 16.60 | 7.00 | 11.60 | 4.00 | 30.0 |
| alcohol (IPA) | | | | | |
| Glycerin | 2.50 | 2.50 | 2.50 | 0.0 | 2.50 |
| Triethyl Citrate | 0.0 | 0.0 | 0.0 | 5.60 | 0.0 |
| Urea | 0.0 | 0.0 | 0.0 | 5.00 | 0.0 |
| Water | QS | QS | QS | QS | QS |
| pH | 6.50 | 6.50 | 6.50 | 6.50 | 6.50 |
| SLS:IPA | 1:2.6 | 1:1.1 | 1:1.8 | 1:0.71 | 1:4.6 |
| Weight Ratio | | | | | |
| SLS:Active | 1.3:1 | 1.3:1 | 1.3:1 | 1.1:1 | 1.3:1 |
| Weight Ratio | | | | | |

¹Available from Lebermuth (South Bend, IN).
²Available from Ernesto Ventos (Spain).
³Available from Symrise (Germany).

TABLE 6

| | Foam | | |
|---|---|---|---|
| | Collapse | Plateau | Plateau |
| | Rate | Time | Height |
| | (mm/sec) | (sec) | (mm) |
| Raid Bed Bug⁶ | 0.16 | 16.6 | 117 |
| Raid Bed Bug MAX⁷ | 0.11 | 15.6 | 117 |
| Amdro Carpenter Bee Foam⁸ | 0.11 | 15.9 | 120 |
| SPECTRACIDE ® Carpenter Bee Foam⁹ | 0.11 | 15.6 | 115 |
| SPECTRACIDE ® Termite Foam¹⁰ | 0.00 | 15.4 | 112 |
| SPECTRACIDE ® Weed and Grass¹¹ | 0.12 | 15.5 | 123 |
| Formula 2 | 0.67 | 15.8 | 123 |
| Formula 6 | 0.23 | 15.8 | 121 |
| Formula 7 | 0.55 | 15.7 | 117 |
| Formula 8 | 0.50 | 16.0 | 113 |
| Formula 9 | 1.42 | 15.0 | 86 |

⁶Active ingredient: clothianidin (0.4%), metofluthrin (0.01%) and piperonyl butoxide (1.0%)
⁷Active ingredients: 3-phenoxybenzyl-(1RS, 3RS, 1RS, 3SR)-2, 2-dimethyl-3-(2-methylprop-1-enyl) cyclopropanecarboxylate (0.4%), *N-octyl bicycloheptene dicarboximide (1.0%)
⁸Active ingredient: Fipronil (0.005%)
⁹Active ingredients: Prallethrin (0.025%) and lambda-cyhalothrin (0.01%)
¹⁰Active ingredients: Prallethrin (0.025%) and lambda-cyhalothrin (0.01%)
¹¹Active ingredients: Diquat dibromide (0.18%), fluazifop-p-butyl (0.06%), and dicamba, dimethylamine salt (0.04%)

The data in Table 6 shows that all the compositions tested produce approximately the same Foam Plateau Heights at similar times (Plateau Times), with the exception of Example 9. It was found that Examples 2, 6, 7, and 8 each exhibit a Foam Collapse Rate of 0.23 mm/see or greater, while the commercially available compositions exhibited a Foam Collapse Rate of 0.16 mm/sec or less. Thus, while the inventive examples and the commercially available compositions tested form about the same amount of foam at about the same time, the inventive examples have a greater Foam Collapse Rate and collapse faster than the commercially available compositions, which may be particularly desirable for direct application of a pest control composition to a pest. It is noted that the commercially available compositions tested are generally intended to be applied to a surface and are intended to persist (or even expand, such as into cracks and/or crevasses) to address pests that are not readily observed such as carpenter bees and bed bugs. In contrast, Examples 2 and 6-9 are intended to be applied directly to a pest in order to trap and/or cover the pest. For a pest control product that is intended to be applied directly to a pest, it may be desirable that the pest control composition comprise a foam or generate a foam, when dispensed, that can sufficiently cover and/or trap the pest long enough to conceal the pest's incapacitation, but not so long that wiping, cleaning and/or removal of the foam is difficult or messy for the consumer to clean up.

It was found that Example 9, which exhibits a Foam Plateau Height of 86 mm and a Foam Collapse Rate of 1.4 mm/sec, may not have sufficient foam height to cover the pest adequately, and the foam may collapse too quickly to effectively trap the pest.

### Combinations

Paragraph 1. A pest control product comprising:
a. a foam dispenser attached to a reservoir,
b. a pest control composition contained in the reservoir, wherein the pest control composition comprises:
   i. from about 0.2% to about 10% by weight of the composition of sodium lauryl sulfate;
   ii. from about 0.005% to about 15% by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof, preferably chosen from geraniol, cornmint oil, peppermint oil, spearmint oil, rosemary oil, lemongrass oil, and mixtures thereof;
   iii. from about 2.5% to about 32% by weight of the composition of a first solvent, wherein the first solvent is isopropyl alcohol; and
   iv. from about 50% to about 95% by weight of the composition of water.

Paragraph 2. The pest control product according to paragraph 1, wherein the weight ratio of sodium lauryl sulfate to isopropyl alcohol is from about 2:1 to about 1:12.

Paragraph 3. The pest control product according to paragraphs 1 or 2, wherein the pest control composition has a Foam Collapse Rate ranging from about 0.20 mm/sec to about 1.2 mm/sec, as determined by the Foam Collapse Test Method.

Paragraph 4. The pest control composition according to paragraphs 1 or 2, wherein the composition exhibits at least one, preferably at least two, more preferably at least three of the following: a Foam Decay Rate of from about 0.20 mm/sec to about 1.0 mm/see in accordance with the Foam Lather Method; a 25% Liquid Drainage Time of from about 25 seconds to about 50 seconds in accordance with the Foam Lather Method; a Drainage Half-Life Time of from about 32 seconds to about 70 seconds in accordance with the Foam Lather Method; and a Max Foam Volume of from about 130 mL to about 180 mL in accordance with the Foam Lather Method.

Paragraph 5. The pest control product according to any one of paragraphs 1-4, wherein the foam dispenser is a mechanical foam dispenser or an aerosol foam dispenser.

Paragraph 6. The pest control product according to any one of paragraphs 1-5, wherein the pest control composition further comprises from about 0.1% to about 10% by weight of the composition of a second solvent selected from the group consisting of triethyl citrate, isopropyl myristate, propylene carbonate, ethyl lactate, butyl lactate, butyl stearate, glycerin, urea, and mixtures thereof, preferably glycerin, more preferably from about 0.1% to about 5% by weight of the composition of glycerin.

Paragraph 7. The pest control product according to any one of paragraphs 1-6, wherein the pest control composition comprises from about 0.5% to about 8% by weight of the composition of an active ingredient chosen from geraniol, cornmint oil, peppermint oil, rosemary oil, lemongrass oil, or mixtures thereof.

Paragraph 8. The pest control product according to any one of paragraphs 1-7, wherein the weight ratio of sodium lauryl sulfate to active ingredient is from about 1:1 to about 20:1.

Paragraph 9. The pest control according to any one of paragraphs 1-8, wherein the composition comprises from about 1% to about 15% by weight of the composition of an active ingredient selected from the group consisting of from geraniol, cornmint oil, lemongrass oil, rosemary oil, and mixtures thereof.

Paragraph 10. The pest control product according to any one of paragraphs 1-9, wherein the composition comprises from about 0.5% to about 10% by weight of the composition of geraniol.

Paragraph 11. The pest control product according to any one of paragraphs 1-10, wherein the composition comprises from about 0.5% to about 5% by weight of the composition of cornmint oil.

Paragraph 12. The pest control product according to any one of paragraphs 1-11, wherein the composition further comprises a carboxylic acid selected from the group consisting of citric acid, malic acid, acetic acid, fumaric acid, humic acid, salts thereof, and mixtures thereof.

Paragraph 13. The pest control product according to any one of paragraphs 1-12, wherein the composition has a pH of about 3 to about 9.

Paragraph 14. The pest control product according to any one of paragraphs 1-13, wherein the composition has a turbidity less than about 20 NTU and greater than about 0 NTU, preferably less than about 10 NTU and greater than about 0 NTU.

Paragraph 15. The pest control product according to any one of paragraphs 1-14, wherein the composition has a b* value of about 0 to about 5.

Paragraph 16. The pest control product according to any one of paragraphs 1-15, wherein the composition comprises particles having an intensity mean particle size or volume mean particles size from about 2 nm to about 100 nm, as measured according to the Particle Size Test Method.

Paragraph 17. The pest control product according to any one of paragraphs 1-16, wherein the composition comprises from about 3% to about 35% by weight of volatile organic compound (VOC).

Paragraph 18. The pest control product according to any one of paragraphs 1-17, wherein the composition is substantially free of synthetic pesticides, mineral oil, colorants, antifoam agents, or a combination thereof.

Paragraph 19. The pest control product according to any one of paragraphs 1-18, wherein the reservoir is transparent or translucent.

Paragraph 20. The pest control product according to any one of paragraphs 1-19, wherein the active ingredients are food use safe, preferably all the ingredients are food use safe.

Paragraph 21. The pest control product according to any one of paragraphs 1-20, wherein the composition is a spray composition.

Paragraph 22. A method of controlling a pest comprising: i) dispensing, preferably spraying, the pest control product according to any one of paragraphs 1-21 on the pest to generate a foam on the pest; ii) optionally, waiting for the foam to collapse, iii) optionally, wiping up the composition.

Paragraph 23. A process for making an aqueous pest control composition, wherein the composition comprises sodium lauryl sulfate, a solvent selected from the group consisting of isopropyl alcohol, glycerin, and mixtures thereof, and a hydrophobic active ingredient chosen from corn mint oil, lemongrass oil, rosemary oil, geraniol, and mixtures thereof, the process comprising the steps of:
a. combining the sodium lauryl sulfate, the hydrophobic active ingredient, and the solvent, to make an active ingredient premix;
b. combining the active ingredient premix with an aqueous phase comprising water and an optional ingredient selected from a pH modifying agent, a preservative, or mixture thereof to form the aqueous pest control composition;
wherein the aqueous pesticidal composition has a pH of about 3 to about 9, a turbidity less than about 20 NTU and greater than about 0 NTU, and a b value of about 0 to about 4.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pest control product comprising:
a. a foam dispenser attached to a reservoir,
b. a pest control composition contained in the reservoir, wherein the pest control composition comprises:
i. from about 0.2% to about 10% by weight of the composition of sodium lauryl sulfate;
ii. from about 0.005% to about 15% by weight of the composition of an active ingredient chosen from cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof;
iii. from about 2.5% to about 25% by weight of the composition of a first solvent, wherein the first solvent is isopropyl alcohol; and
iv. from about 50% to about 95% by weight of the composition of water;
wherein the weight ratio of sodium lauryl sulfate to isopropyl alcohol is from about 2:1 to about 1:12.

2. The pest control product of claim 1, wherein the weight ratio of sodium lauryl sulfate to active ingredient is from about 1:1 to about 20:1.

3. The pest control product of claim 2, wherein the pest control composition further comprises from about 0.1% to about 10% by weight of the composition of a second solvent chosen from triethyl citrate, isopropyl myristate, propylene carbonate, ethyl lactate, butyl lactate, butyl stearate, glycerin, urea, or mixtures thereof.

4. The pest control product of claim 1, wherein the composition has a pH of about 3 to about 9.

5. The pest control product of claim 1, wherein the pest control composition is substantially free of synthetic pesticides, mineral oil, colorants, antifoam agents, or a combination thereof.

6. The pest control product of claim 1, wherein the foam dispenser is a mechanical foam dispenser or an aerosol foam dispenser.

7. The pest control product of claim 1, wherein the reservoir is transparent or translucent.

8. The pest control product of claim 1, wherein the pest control composition exhibits at least one of the following: a Foam Decay Rate of from about 0.20 mm/sec to about 1.0 mm/sec in accordance with the Foam Lather Method; a 25% Liquid Drainage Time of from about 25 seconds to about 50 seconds in accordance with the Foam Lather Method; a Drainage Half-Life Time of from about 32 seconds to about 70 seconds in accordance with the Foam Lather Method; and a Max Foam Volume of from about 130 mL to about 180 mL in accordance with the Foam Lather Method.

9. The pest control product of claim 1, wherein the composition comprises from about 0.05% to about 35% by weight of volatile organic compound (VOC).

10. The pest control product of claim 1, wherein the pest control composition has a turbidity less than about 20 NTU and greater than about 0 NTU.

11. The pest control product of claim 1, wherein the pest control composition has a b* value of about 0 to about 5.

12. A pest control composition comprising:
a. from about 0.2% to about 10% by weight of the composition of sodium lauryl sulfate;
b. from about 0.005% to about 15% by weight of the composition of an active ingredient chosen from cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof;
c. from about 2.5% to about 25% by weight of the composition of a first solvent, wherein the first solvent is isopropyl alcohol; and
d. from about 50% to about 95% by weight of the composition of water;
wherein the pest control composition exhibits a 25% Liquid Drainage Time of from about 25 seconds to about 50 seconds as measured according to the Foam Lather Method;
wherein the pest control composition is a foam;
wherein the foam has a specific volume of from about 3 ml/g to about 20 ml/g.

13. The pest control composition of claim 12, wherein the weight ratio of sodium lauryl sulfate to isopropyl alcohol is from about 2:1 to about 1:12.

14. The pest control composition of claim 12, wherein the pest control composition comprises from about 0.5% to about 8% by weight of the composition of the active ingredient, wherein the active ingredient is chosen from geraniol, cornmint oil, peppermint oil, rosemary oil, lemongrass oil, or mixtures thereof.

15. The pest control composition of claim 14, wherein the composition further comprises a carboxylic acid chosen from citric acid, malic acid, acetic acid, fumaric acid, humic acid, salts thereof, or mixtures thereof.

16. The pest control composition of claim 12, wherein the composition comprises from about 0.05% to about 35% by weight of volatile organic compound (VOC).

17. The pest control composition of claim 12, wherein the composition is substantially free of synthetic pesticides, mineral oil, colorants, antifoam agents, or a combination thereof.

18. A method of controlling a pest, the method comprising:
applying a pest control composition to a pest; wherein the pest control composition comprises:
a. from about 0.2% to about 10% by weight of the composition of sodium lauryl sulfate;
b. from about 0.005% to about 15% by weight of the composition of an active ingredient chosen from cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof;
c a first solvent, wherein the first solvent is isopropyl alcohol; and
d. from about 50% to about 95% by weight of the composition of water;
wherein the pest control composition is dispensed from a foam dispenser as a foam;
wherein the weight ratio of sodium lauryl sulfate to isopropyl alcohol is from about 2:1 to about 1:12.

19. The method of claim 18, wherein the pest control composition exhibits a Drainage Half-Life Time of from about 32 seconds to about 70 seconds.

20. The method of claim 18, wherein the pest control composition has Delta Average Bubble Radius of at least 9 μm.
